(19) United States
(12) Patent Application Publication
(10) Pub. No.: US 2014/0334244 A1
(43) Pub. Date: Nov. 13, 2014

(54) Apparatus for Seeding a Fluid with Tracing Material

(71) Applicant: University of Manitoba, Winnipeg (CA)

(72) Inventors: Madjid Birouk, Winnipeg (CA); Meghdad Saediamiri, Winnipeg (CA); Janusz A. Kozinski, Toronto (CA)

(21) Appl. No.: 13/892,935

(22) Filed: May 13, 2013

(51) Int. Cl. F16K 1/38; B01F 15/02

(52) U.S. Cl. CPC F16K 1/385; B01F 15/02
USPC 366/131; 251/205

(57) ABSTRACT

A new seeder for laser-based velocity measurements in gaseous combusting and non-combusting flows is described herein. The performance of the seeder was tested under a variety of flow rate conditions. The testing revealed that control over the concentration of seeding particles, stability of particles supply, extended range of flow rate, and breakup of the agglomerates makes the newly designed seeder advantageous over its counterparts, especially for weak flow rates applications.

### FIELD OF THE INVENTION

The present invention relates to an apparatus for seeding a tracing material, for example micro-particles, into a carrier fluid, for example a flow of gas, using a seeding chamber having a sump area for receiving the tracing material and a flow area above the sump area for receiving a flow of the carrier fluid across the tracing material in the sump area. More particularly, the present invention relates to a seeding apparatus used in laser-based velocity measurements in flames. The present invention further relates to a sonic valve for use with the seeding apparatus.

### BACKGROUND

Measurement of fluid dynamics characteristics using non-intrusive laser-based techniques, such as particle image velocimetry (PIV) and laser Doppler velocimetry (LDV), requires seeding the fluid with micro-sized particles. These particles, which act as tracing material for the fluid motion, must have proper size and concentration/density in a flow field. Tracers should also be distributed uniformly and supplied steadily. In combusting flows, seeding particles such as liquid droplets, smokes, and solid carbon dioxide cannot be used as tracers. Thus, only inert solid powders/particles can be used in high-temperature (combustion) fluid flows. In addition to flames, solid particles are also favorable over other seeding material as tracers when high particles concentration in a fluid flow is required. Moreover, in enclosed flow devices (e.g., chambers/containers) liquid-based droplets/particles tend to deposit quickly on the viewing optical windows and also refract laser beams while solid particles only attenuate laser beams [1]. Furthermore, higher intensity of light scattering from solid particles in comparison with that from smoke and liquid-based droplets/particles is advantageous for particle image velocimetry (PIV) and laser Doppler velocimetry (LDV) measurements.

There exist a variety of seeding particles generators such as a cyclone aerosol particles generator [1-3], a rotary brush seeder [2], atomization of suspensions of solid particles with a volatile solvent [1,4], a fluidized bed [1,5], a two-phase fluidized bed [1], a mechanically agitated fluidized bed [5,6] and horizontal drum seeders [7]. The literature showed that powder seeders and fluidized beds are the most practically adopted techniques. However, there are still several practical problems associated with solid powders/particles due to the agglomeration of particles and also due to the difficulty in maintaining a steady supply of seeding particles, especially at low flow rates. A brief description of these different seeding techniques and generators which were used for velocity and turbulence quantities measurements in gaseous flow via LDV or PIV is briefly presented below.

### Overview of Existing Solid Particles Seeders

A seeder using solid carbon dioxide particles is much cleaner since these particles evaporate (no deposit) but it cannot be used in combusting flows due to the high temperature and its interference with the composition of the flow. The size of these particles for higher velocity and turbulent measurements is relatively large and so controlling the size of these particles along the flow field is a challenge for these types of seeders [8,9].

A schematic diagram of a rotary brush seeder is shown in FIG. 1(a). This type of seeder is one of the basic and simplest ways of seeding gaseous flows. Seeding the flow is achieved by passing the gas flow along a rotating dense brush submerged in a particles' container [2]. However, this type of seeder does not have control over the seeding rate in a flow; that is, the concentration of seeding particles in the flow depends on the volumetric flow rate. In addition, breaking larger agglomerates requires a very high speed flow over the brush [2].

Atomization of suspensions of solid particles with a volatile solvent is a method that produces uniform distribution of particles and steady supply [1,4]. However, the concentration of particles is low and it can only be used in seeding the type of fuels where the solvent is the combusting fuel. Moreover, controlling the pH of the solution of particles and solvent is a critical parameter for generating a uniform distribution of solid particles in the flow. A schematic diagram of this seeder is shown in FIG. 1(b) [1,4].

Cyclone aerosol generators, as shown in FIG. 1(c), use a simple technique which does not involve any mechanically moving parts to feed dry solid particles into a gaseous flow. Moisture content in the carrier flow drastically decreases the performance of this type of seeder and the only mechanism to control the concentration of particles into the gas flow is by controlling the flow rate. Moreover, as seeding particles are being consumed, the distance between the air inlet into the cyclone and the location of the particles increases which consequently leads to a change in the seeder performance [1-3].

A fluidized bed is an advanced seeding technique to produce suspended small particles in a gaseous flow [1, 5, 10]. A schematic diagram of a typical fluidized bed seeder is shown in FIG. 2(a). This seeder, which does not have mechanically moving parts, has a superior performance within its working range. The problem with this seeder is that the moisture content of the gas flow affects its performance drastically due to the agglomeration of particles. Equally the dryness of the gaseous flow can increase particle agglomeration due to electrostatics forces. Moreover, this seeder's performance deteriorates at lower flow rate ranges due to a low concentration of particles and at high flow rates due to the formation of larger particles as a result of agglomerates which in turn increases the clogging phenomenon [1,5,10].

A schematic diagram of a two-phase fluidized bed is shown in FIG. 2(b). A two-phase fluidized bed contains small balls/beads of metal or glass material covered by very small solid particles that eventually seed a flow. Despite its simplicity, a two-phase fluidized bed produces more uniform supply and better performance at low flow rates due to the availability of free spaces between the beads. However, it has a limited operation range in comparison with simple fluidized bed described earlier [1].

A mechanically agitated fluidized bed, as it is shown schematically in FIG. 2(c), is an improved version of the simple fluidized bed where a rotating rod connected to a brush inside the bed was implemented to enhance the performance of the seeder. This brush aims at eliminating the flow channels produced in the bed and hence increases the uniformity of particles supply. This seeder has relatively less sensitivity to the moisture content of the incoming gas but the moisture content still affects significantly its performance [5,6]. Moreover, similar to the aforementioned fluidized-bed seeders, it has a limited flow rate operating range.

The Scitek PS-10 Power Seeder is a horizontal drum seeder [7]. This seeder consists of a container and a rotating drum, which is filled with solid particles. Once rotating, an amount of solid particles drops through a hole, which is located in the middle of the drum, into the container and the gas flow fluidizes these particles inside the container. Control of particles concentration in the gaseous flow is achieved by varying the speed of the rotating drum. This seeder has the advantage of controlling the amount of particles into the flow but is still unable to provide a steady supply at low flow rates. In order to supply adequate concentration of particles at low flow rate, the rotation speed of the drum must be decreased which leads to a periodic supply of particles. In order to improve its performance, the hole size on the drum is decreased and the rotation speed of the drum is increased which consequently limits its operating range [7].

### Controlling the Size of Seeding Particles

The size of seeding particles has a major impact on the measurement quality of a flow's turbulent characteristics and especially turbulence quantities. The higher the turbulence frequency, the lower the size of the flow motion tracers should be [1]. Solid particles have a tendency to agglomerate due to either: i) the moisture content in a gaseous flow or ii) the electrostatic forces which results from excessive gas dryness. Since controlling the moisture content of a gaseous flow is a complicated process, several designs were proposed which aimed at separating large agglomerated (large) particles from a flow or break up the agglomerated particles (e.g., seeder shown in FIG. 3). A good example of separating large agglomerated particles is the cyclone particle separator which is schematically shown in FIG. 3(a). However, this technique has a limited operating range as it is flow rate dependent [1,12].

Another more advanced technique is to break up the particle agglomerates by using sonic flow with high shear stress at the seeder's exit/outflow (e.g., [10]). A sonic orifice, as shown in FIG. 3(b), is a simple technique to produce a sonic flow by controlling the pressure in both sides of the seeder. Since a sonic orifice seeder has no moving parts it does not require any maintenance; however, controlling the flow rate is limited to downstream pressure [10]. An improved version is through the use of variable (varying cross-section) sonic valve (which is shown in FIG. 3(c)), which has the ability of changing the exit area of the valve and consequently controls the flow rate. Since the particles have a sharp turn at the exit of the valve after a few runs the sharp turn may cause clogging problems and thus the valve needs to be cleaned regularly [5].

### SUMMARY OF THE INVENTION

According to one aspect of the invention there is provided a seeding apparatus for seeding a carrier fluid with particulate tracing material, the apparatus comprising:

a seeding chamber including an upper flow area arranged to receive a flow of the carrier fluid therethrough and a lower sump area below the upper flow arrange arranged to receive the tracing material therein;

a fluid inlet in communication with the upper flow area of the seeding chamber at a location above the lower sump area so as to be arranged to introduce the carrier fluid into the seeding chamber therethrough;

a fluid outlet in communication with the upper flow area of the seeding chamber at a location above the lower sump area so as to be arranged to discharge the carrier fluid from the seeding chamber therethrough; and

an agitator operatively supported in the seeding chamber so as to be arranged to agitate tracing material in the sump area of the seeding chamber.

When the seeding chamber is elongate in a longitudinal direction between the fluid inlet and the fluid outlet at horizontally opposed ends of the housing, preferably the agitator is supported for rotation about a horizontal axis extending in the longitudinal direction so that radially oriented mixing elements of the agitator are rotated between the sump area and the flow area.

In the illustrated embodiment each mixing element comprises a planar body which is uniformly is perforated.

An adjustable speed motor may be coupled to the agitator to drive rotation of the agitator at an adjustable rate.

The agitator is preferably driven to rotate relative to the seeding chamber by a drive shaft protruding through a wall of the seeding chamber and wherein there is provided a pressure chamber surrounding the drive shaft externally of the seeding chamber which is arranged to be pressurized.

The inlet coupling may include an access opening arranged to introduce tracing material into the seeding chamber therethrough and a cap arranged to selectively enclose the access opening. In this instance, the inlet coupling preferably communicates through a top wall of the seeding chamber.

The seeding apparatus may further comprise a bypass line connected in parallel relationship with the seeding chamber so as to receive a flow of the carrier fluid therethrough, the bypass line and the inlet coupling each being connected in series with a respective control valve and the control valves being connected to a common supply of the carrier fluid.

The seeding apparatus may further comprise a sonic valve assembly in communication with the fluid outlet of the seeding chamber.

According to a second aspect of the present invention there is provided a sonic valve assembly for receiving a flow of carrier fluid containing particulate tracing material therein, the valve assembly comprising:

a valve body having an inlet opening, an outlet opening, and a valve seat defining a valve opening between the inlet opening and the outlet opening; and

a valve member received within the valve body and being movable relative to the valve opening in an axial direction of the outlet opening so as to adjust an effective size of the valve opening.

The valve seat may comprise a generally conical surface which is reduced in diameter towards the valve opening in a direction from the inlet opening towards the outlet opening. In this instance, the valve member may include an end portion which is generally conical so as to be reduced in diameter towards an apex in the axial direction.

The valve member may be supported relative to the valve body by a threaded connection so as to adjust a position of the valve member relative to the valve body by rotation of the valve member relative to the valve body.

One embodiment of the invention will now be described in conjunction with the accompanying drawings in which:

### BRIEF DESCRIPTION OF THE DRAWINGS

FIG. 1(a) is a schematic diagram of a Rotary brush seeder;

FIG. 1(b) is a schematic diagram of a Volatile solvent seeder;

FIG. 1(c) is a schematic diagram of a Cyclone seeder.

FIG. 2(a) is a schematic diagram of a fluidized bed seeder;

FIG. 2(b) is a schematic diagram of a two-phase fluidized bed seeder;

FIG. 2(c) is a schematic diagram of a mechanically agitated fluidized bed.

FIG. 3(a) is a schematic diagram of a cyclone particle separator;

FIG. 3(b) is a schematic diagram of a sonic orifice;

FIG. 3(c) is a schematic diagram of a variable sonic valve;

FIG. 4(a) is a schematic diagram of a seeding chamber according to the seeding apparatus of the present invention;

FIG. 4(b) is a perspective view of a variable sonic valve according to the seeding apparatus of the present invention;

FIG. 4(c) is a sectional view of the variable sonic valve of FIG. 4(b);

FIG. 4(d) is a perspective view of the agitator of the seeding chamber according to FIG. 4(a);

FIG. 5(a) is a perspective view of the seeding apparatus of the present invention;

FIG. 5(b) is a schematic diagram of the seeding apparatus of the present invention;

FIGS. 6(a), 6(b) and 6(c) illustrate seeding particles distribution in a jet issuing from a pipe at constant flow rate (1.5 LPM) at low, medium, and high rotational speed of the agitator respectively;

FIGS. 7(a) and 7(b) represent a number of valid velocity vectors in 2030 pairs of PIV images at different flow rates of (half of the jet) seeded by using the mechanically agitated fluidized bed and the new seeding apparatus respectively;

FIG. 8 graphically represents a number of valid velocity vectors in 2030 pairs of PIV images at different flow rates along the centerline of the jet;

FIGS. 9(a) and 9(b) graphically illustrate the effect of seeding particle concentration on the jet for centerline mean-velocity decay and fir the corresponding number of valid PIV velocity vectors (Vjet=8 m/s, D=6.5 mm) respectively;

FIGS. 10(a) and 10(b) graphically illustrate the effect of seeding particles concentration on the jet for centerline mean-velocity decay and for the corresponding number of centerline valid PIV velocity vectors (Vjet=15 m/s, D=6.5 mm) respectively;

FIGS. 11(a), 11(b) and 11(c) illustrate the effect of the position of the sonic valve on the breaking up of agglomerated particles at constant flow rate (1.5 LPM) when fully open, half open, and sonic respectively;

FIGS. 12(a) and 12(b) graphically illustrate the effect of the position of the sonic valve on the jet for centerline mean-velocity decay and for the corresponding number of valid PIV velocity vectors (Vjet=8 m/s, D=6.5 mm) respectively;

FIGS. 13(a) and 13(b) graphically illustrate a comparison of the jet for centerline mean-velocity decay and for the corresponding number of valid PIV velocity vectors between the MFS and NS at a low flow rate (Vjet=3.7 m/s, D=6.5 mm) respectively;

FIGS. 14(a) and 14(b) graphically illustrate a comparison of the jet for centerline mean-velocity decay, and for the corresponding number of valid velocity vectors between the MFS and NS at a moderate flow rate (Vjet=8 m/s, D=6.5 mm) respectively;

FIGS. 15(a) and 15(b) graphically illustrate a comparison of the jet for centerline mean-velocity decay, and for the corresponding number of valid velocity vectors between the MFS and NS at a relatively high flow rate (Vjet=15 m/s, D=6.5 mm) respectively; and

FIGS. 16(a) and 16(b) graphically illustrate jet centerline mean-velocity decay and its corresponding turbulence intensity in the jet near field (r₀* and rₗ* are defined in [16]) respectively.

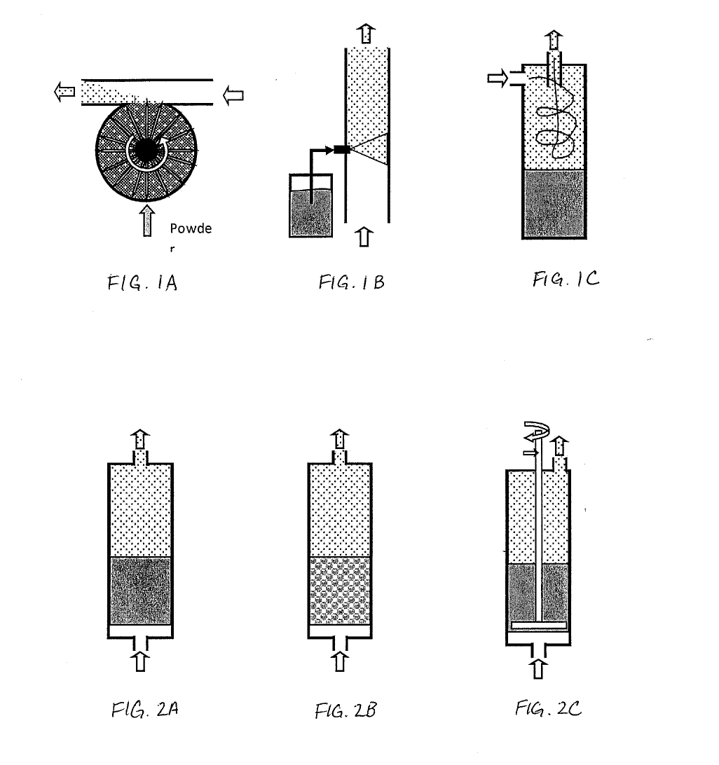

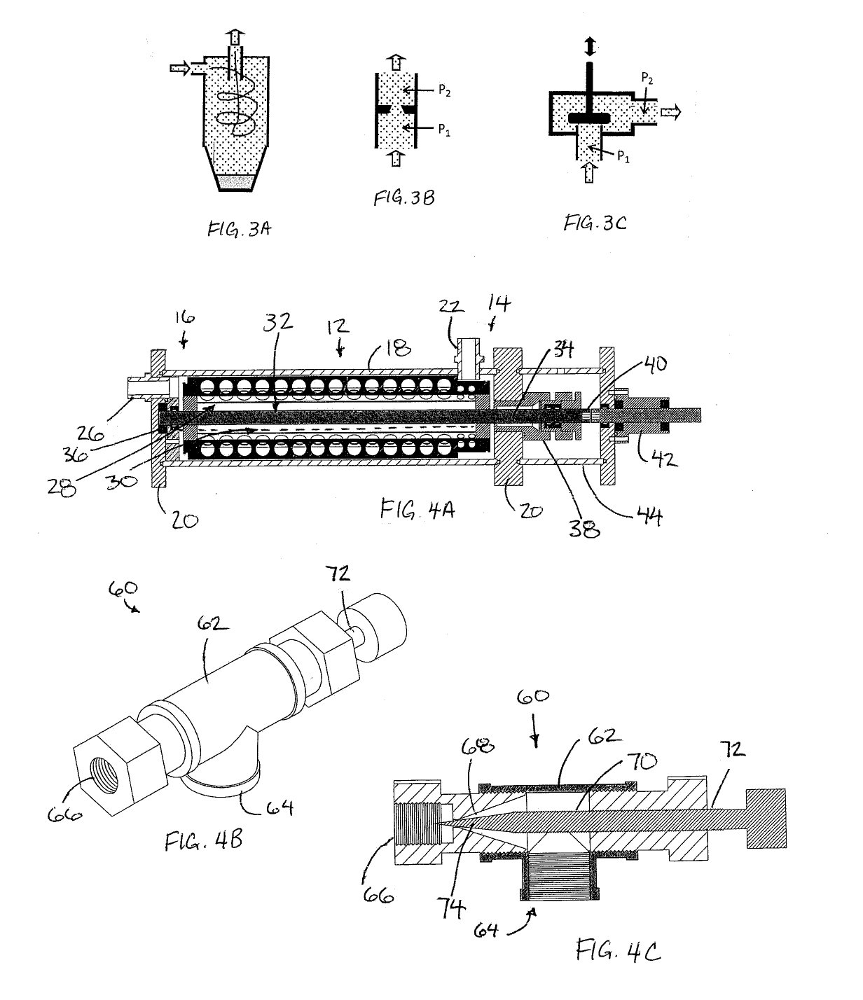

In the drawings like characters of reference indicate corresponding parts in the different figures.

### DETAILED DESCRIPTION

### Design of a New Seeder

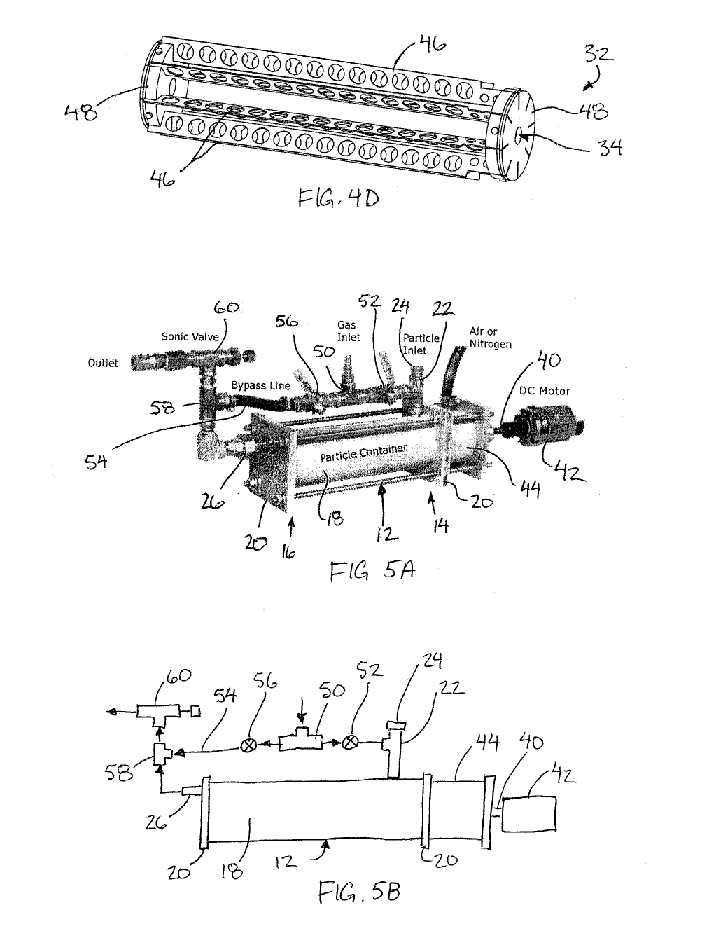

Referring initially to FIGS. 4 and 5, there is illustrated a seeding apparatus generally indicated by reference numeral 10. The apparatus 10 is particularly suited for seeding a tracing material, for example micro sized particulate material into a carrier fluid, for example a gas flow.

The apparatus 10 includes a seeding chamber 12 which generally cylindrical and elongate in a horizontal direction to extend axially between an inlet end 14 and an outlet end 16. The chamber is bound by an outer cylindrical wall 18 spanning horizontally in the longitudinal direction of the chamber between end walls 20 at the inlet and the outlet ends respectively.

An inlet coupling 22 is mounted in communication with the seeding chamber through the outer wall 18 at the top side thereof adjacent the inlet end of the chamber. The inlet coupling 22 is arranged to introduce the flow of carrier fluid into the seeding chamber in operation. When not in operation, the inlet coupling 22 includes an upper opening selectively enclosed by a threaded cap 24 which permits the tracing material to be introduced into the seeing chamber therethrough when the cap is removed.

An outlet coupling 26 communicates with the seeding chamber through the end wall at the outlet end 16 adjacent the top end thereof. The outlet coupling is arranged to discharge the carrier fluid from the seeding chamber therethrough once the carrier fluid has been seeded with the tracing material within the seeding chamber.

Both the inlet and outlet couplings are located adjacent the top side of the seeding chamber so as to define a flow area 28 occupying the upper half of the seeding chamber where the carrier fluid is permitted to flow longitudinally from the inlet end to the outlet end primarily within the upper half of the seeding chamber. A sump area 30 is thus defined below the flow area such that the sump area extends in the longitudinal direction along the bottom half of the chamber between the inlet and outlet ends where the tracing material is arranged to settle. The level of tracing material in the chamber may substantially fully occupy the sump area corresponding to the bottom half of the seeding chamber.

An agitator 32 is supported within the seeding chamber for operation between the sump area 30 and the flow area 28 thereabove to carry the settled tracing material in the sump area upwardly into the flowing carrier fluid in the flow area. The agitator 32 includes a shaft 34 concentrically supported in the cylindrical seeding chamber to extend horizontally and longitudinally between the opposing end walls 20.

An outlet bearing 36 supports one end of the shaft 34 at the inner side of the outlet end wall such that the outlet end of the shaft and the outlet bearing 36 are fully contained within the boundary of the chamber to be fully pressurized together with the hollow interior of the seeding chamber in operation and therefore prevent any leakage to the exterior at the outlet bearing. An inlet bearing 38 is mounted in the inlet end wall to receive the shaft extending therethrough so that the shaft is accordingly rotatably supported relative to both of the end walls.

At the exterior of the end wall of the chamber the shaft is connected to an axle 40 for rotation together relative to the walls of the chamber. The axle 40 is connected to an electric variable speed motor 42 for driving rotation of the agitator shaft relative to the chamber. A pressure chamber 44 surrounds the portion of the shaft protruding outwardly from the seeding chamber at the inlet end wall as well as the axle connected thereto. The pressure chamber 44 fully surrounds the shaft and is arranged to be connected to a source of air under pressure so that the chamber about the exterior side of the inlet bearing 38 can be pressurized to a pressure which is equal or greater than the working pressure within the seeding chamber to prevent leakage of the carrier fluid through the inner end wall.

The agitator further comprises a plurality of mixing elements 46 which are mounted at evenly circumferentially spaced positions about the shaft and so as to be oriented generally in the radial direction relative to the shaft. The mixing elements are supported by two end plates 48 which are generally circular and fixed at opposing ends of the shaft to extend radially outward within the respective planes oriented perpendicularly to the shaft. In the illustrated embodiment 8 elements 46 are evenly spaced apart from one another in the circumferential direction.

Each mixing element 46 comprises a planar paddle which extends longitudinally between opposed ends fixed to the two end plates 48 respectively. Furthermore, each mixing element spans radially outward from an inner edge spaced outward from the shaft to an outer edge in proximity to the cylindrical outer wall 18 of the seeding chamber. The radial distance from the shaft to the inner edge of each mixing element as approximately equal to the radial dimension between the inner and outer edges of the element.

Each paddle further includes a plurality of apertures formed therein at spaced positions in the longitudinal direction such that the apertures are evenly distributed along the full length resulting in a perforated mixing element. The planar surface of the mixing element is well suited for lifting considerable amounts of the tracing material settled in the sump area upwardly into the flow area while the perforations enhance the fluid flow about the surfaces of the mixing elements carrying the tracing material thereon from the sump area to the flow area.

The apparatus 10 further comprises a carrier fluid source which communicates with an inlet tee 50 which separates the initial flow from the source into a first branch line directed towards the inlet coupling and an opposing second branch line in parallel with the first branch line. A first valve 52 is coupled in series with the first branch line between the inlet tee 50 and the inlet coupling 22 to adjustably control the volume of carrier fluid flow to the inlet coupling and thus through the seeding chamber.

The second branch line comprises a by-pass line 54 which is arranged to receive the carrier fluid flow therethrough in parallel relation with the seeding chamber. A second valve 56 is connected in series with the by-pass line to adjustably control the volume of carrier fluid flow through the by-pass line relative to the seeding chamber.

The first and second valves are adjustable such that all of the flow can be directed to the seeding chamber for lower volume flows, or alternatively an adjustable portion of the carrier fluid flow can be redirected through the by-pass line in parallel with the seeding chamber for high speed flows where it is desirable to limit the overall speed of flow through the seeding chamber. An outlet tee 58 joins the by-pass line 54 and the outlet of the outlet coupling 26 so that flows from both connections to the outlet tee can be subsequently directed to a sonic valve 60.

The sonic valve generally includes a valve body 62 having an inlet opening 64 and an outlet opening 66. A generally cylindrical chamber within the body 62 is coaxial with the outlet opening and a valve seat 68 defined within the inner body. In particular the valve seat 68 comprises a generally conical surface which is reduced in diameter towards an orifice which defines a valve opening or nozzle by being reduced in diameter in a direction from the inlet opening towards the outlet opening. The inlet opening 64 communicates within the inner chamber within the cylindrical body in a radial direction relative to the axis of the cylindrical chamber and outlet opening.

The sonic valve 60 further includes a shuttle or valve member 70 which has a generally elongate and cylindrical body received within the chamber of the valve body 62 such that an outer diameter of the valve member body is much smaller in diameter than the chamber of the valve body while being larger in diameter than the orifice or valve opening defined by the seat 68. The valve member extends in the axial direction of the outlet opening from a mounting end 72 which is mounted in threaded connection through one end of the valve body axially opposite from the outlet opening to an opposing working end 74.

The working end portion is generally conical so as to be reduced in diameter from the outer diameter of the cylindrical body portion to an apex which is smaller in diameter than the orifice. The axial position of the valve member body is adjusted relative to the valve body 62 by rotating the valve member relative to the valve body to displace the valve member in the axial direction of the outlet opening relative to the valve seat 68. When fully open the valve opening or orifice is unobstructed by the valve member. By advancing the valve member towards the outlet opening, the reduced diameter working end 74 of the valve member can be inserted into the valve opening of the seat 68 by varying amounts to obstruct the orifice by varying amounts. By varying the portion of the orifice unobstructed by the valve member, the effective size of the valve opening is adjusted to optimize the sonic flow through the valve body to reduce agglomerations of tracing material within the carrier fluid.

In use, the sump area is initially filled with tracing material through the inlet coupling, for example to a level indicated by the broken line in FIG. 4(a). Once the cap of the inlet coupling is replaced and the pressure chamber is pressurized, fluid flow can be introduced through the seeding chamber primarily in the flow area from the inlet coupling to the outlet coupling. Rotating the agitator by varying speeds will vary the concentration of tracing material which is lifted from the sump area into the flow area for being collected within the flow of carrier fluid exiting the seeding chamber. Substantially all of the carrier fluid flow can be directed through the seeding chamber for slower flows if desired; however, adjustment of the first and second valves permits varying amounts of the carrier fluid to be re-directed through the by-pass line in parallel to the seeding chamber for higher speed carrier fluid flows. The position of the valve member within the sonic valve is adjusted to optimize sonic flow through the valve body and break up agglomerates of tracing material as described above.

The main objective of the present invention is the design a new seeder which aims to resolve the seeding issues briefly discussed above. The design adopted in the new seeder aims at i) enlarging the flow operability range, ii) ensure steady and uniform supply of particles, and iii) having control over the concentration and size of particles independently of the volumetric flow rate and moisture content in a gaseous flow. A schematic diagram of the new seeder is shown in FIG. 4(a). The concept of this seeder is to mechanically agitate solid particles inside a horizontal container to producing fluidized particles. The seeding particles concentration is controlled by the speed of a rotating brush independently of the flow rate. To break up the particle agglomerates, a sonic valve is used at the exit/outflow of the seeder as shown in FIG. 4(b). In addition, the flow direction in the sonic valve is altered to avoid the clogging problem.

A photographic picture of the new seeder is provided in FIG. 5. As shown in this figure, the seeder mainly consists of a horizontal cylinder divided into two compartments. The cylinder diameter is about 90 mm. The smaller compartment connects to a pressurized supply line of air or nitrogen, which is needed to balance the pressure between the two compartments for the purpose of sealing the seeder. The larger compartment contains solid particles and a rotary brush (see FIG. 4(a)) which mechanically agitates the particles and hence produces aerosols of particles agglomerates. When a gaseous flow passes through this compartment it mixes and consequently carries the suspended particle agglomerates. The concentration of particles in the flow is controlled by varying the speed of a DC motor connected to the brush. The design includes also a bypass line to control the over flow through the seeder for extremely high speed flows. The technique of high shear stress of a sonic flow is adopted in this design to break the large agglomerates to smaller ones. Moreover, a variable sonic valve is employed to achieve a choked flow over a wide range of jet flow conditions.

### EXPERIMENTAL PROCEDURE

To assess the performance of the new seeder, an existing atmospheric flame/burner test rig was employed and used in a laboratory for studying the stability of turbulent jet flames. Details of the test apparatus is reported in [13,14]; however, a brief description is provided as follows. The atmospheric burner consists mainly of an interchangeable fuel nozzle attached to a central supply pipe, which is, in turn, connected to a supply cylinder of fuel (or to a compressed air supply line; which what was used in the present tests). The central pipe is surrounded by an annulus which is used for supplying co-airflow delivered from a laboratory compressed supply line. However, in the present tests only the central air jet is used. The flow rate along with the exit cross-sectional area of the nozzle (or pipe, see Table 1) is used to determine the exit velocity (i.e. bulk velocity). The selected jet airflow rate, which is supplied to the burner from a laboratory compressed air line, mixes with the seeding particles in the seeder, and then flows through the central pipe before discharging into the atmosphere from the nozzle/pipe. The existing seeder, which is a mechanically agitated fluidised bed seeder was described in [15]. A Dantec Dynamics two-dimensional particle image velocimetry (PIV) was used to measure the flow instantaneous velocity profiles. The PIV system consists mainly of a 120 mJ/pulse laser with 532 nm wavelength to illuminate the flow field, and a 12-bit high-resolution digital camera (Dantec Dynamic NanoSense MKIII camera) with a 1024 pixels×1260 pixels CCD and 12 μm pixel pitch. The laser sheet was located in the symmetry plane of the jet. Instantaneous image pairs of about 2000 were used to determine the jet flow velocity information. The instantaneous images were processed using 8 pixels×8 pixels interrogation window with a 50% overlap and adaptive correlation. The analysis of 8 pixels×8 pixels and 16 pixels×16 interrogation windows demonstrated that the results were grid independent. The present test conditions are summarized in Table 1 as follows:

TABLE 1
Experimental test conditions

| Nozzle (pipe) | Jet flow rate | Jet exit velocity | Jet exit |
|---|---|---|---|
| Diameter (mm) | (LPM) | Vjet (m/s) | Reynolds number |
| 6.5 mm | 3.70-150 | 1.85-75 | 800-32,400 |

### Results and Discussions

A series of experiments were carried out to assess the newly designed seeder in terms of its ability in 1) performing adequately at low and high flow rate, 2) controlling the particles concentration, and 3) breaking up the larger agglomerates in order to reduce the size of particles.

### Particles Concentration

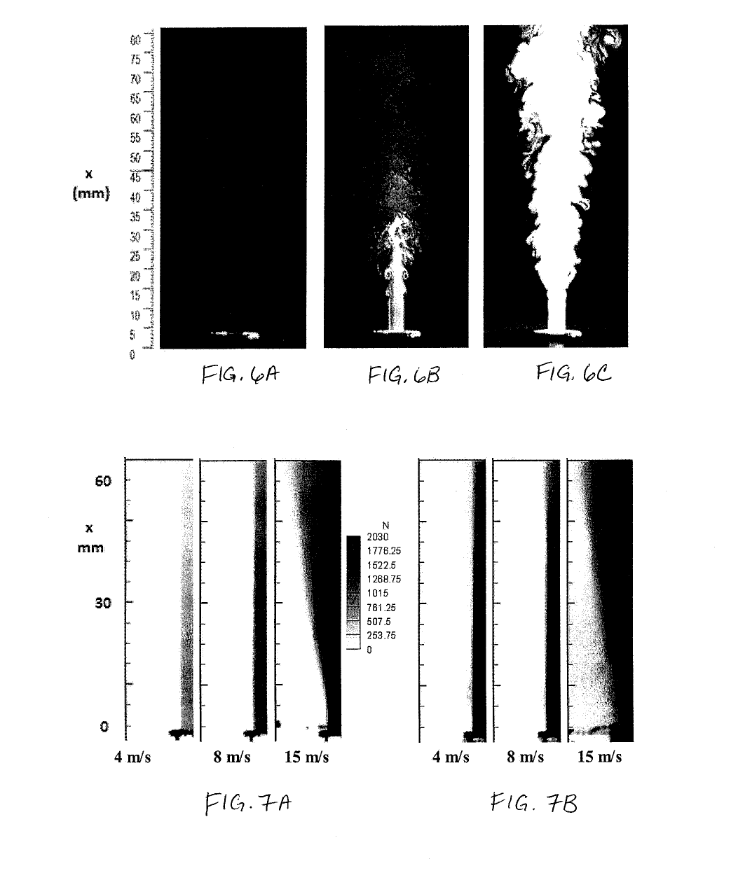

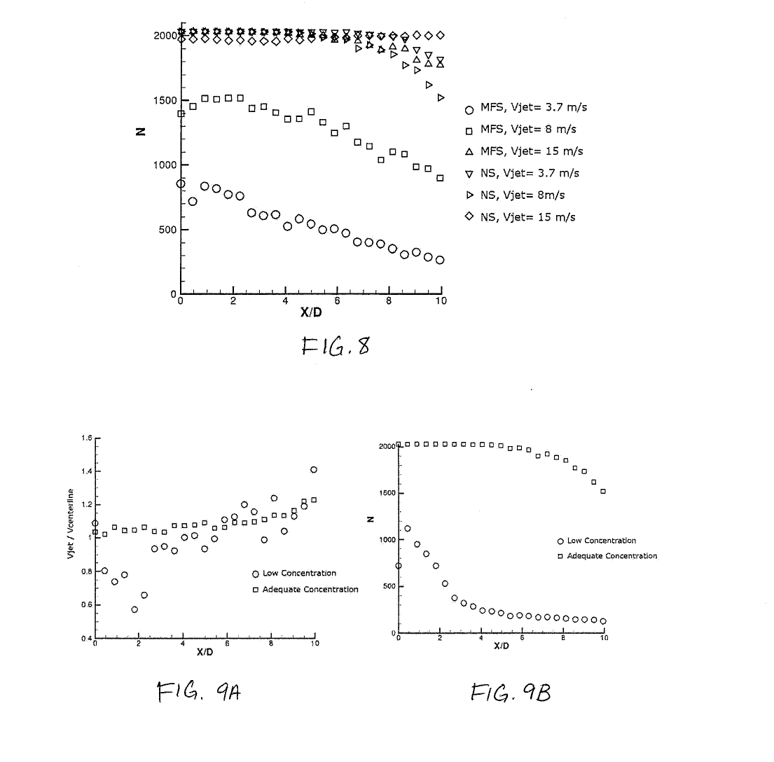

Instantaneous images of air jet flow into a stationary atmospheric ambient is shown in FIG. 6. The jet issues from a pipe with a flow rate of 3.70 LPM. These images illustrate the performance of the new seeder in controlling the concentration of solid particles fed into a gaseous jet flow without changing the flow rate. FIG. 6(a) shows a very weak concentration of particles in the jet which can be achieved by keeping the rotational speed of the brush at low RPM. It is clear that the jet flow is not sufficiently seeded (FIG. 6(a)) and hence any attempt in using laser-based velocity measurements technique will fail. Further increasing the brush rotational speed results in an increase in the concentration of particles in the jet as shown in FIG. 6(b). This figure shows that the flow is sufficiently seeded as the jet is clearly identifiable from its quiescent atmospheric environment. The same figure, however, reveals a relative drop in the seeding particles in the very far-field of the jet. This is due to the fact that the ambient surrounding the jet is unseeded and hence the jet loses seeding particles to the ambient as a result of entrainment/mixing. FIG. 6(c) shows that the concentration of seeding particles in the jet flow's far-field is enhanced by increasing further the rotational speed of the brush without varying the jet flow rate. This feature of the new seeder makes it superior to the existing/published seeders.

FIG. 7 compares the contours of the number of PIV valid velocity vectors for the jet's half between the mechanical agitated fluidized bed seeder (MFS) and the new seeder (NS) at three different flow rates (i.e., jet exit velocity). This figure shows clearly that the new seeder provides much better contours at any jet flow rate. The same figure shows also that the number of PIV valid vectors with the MFS seeder becomes comparable to that of the NS at medium range of jet flow rates (e.g., 15 m/s).

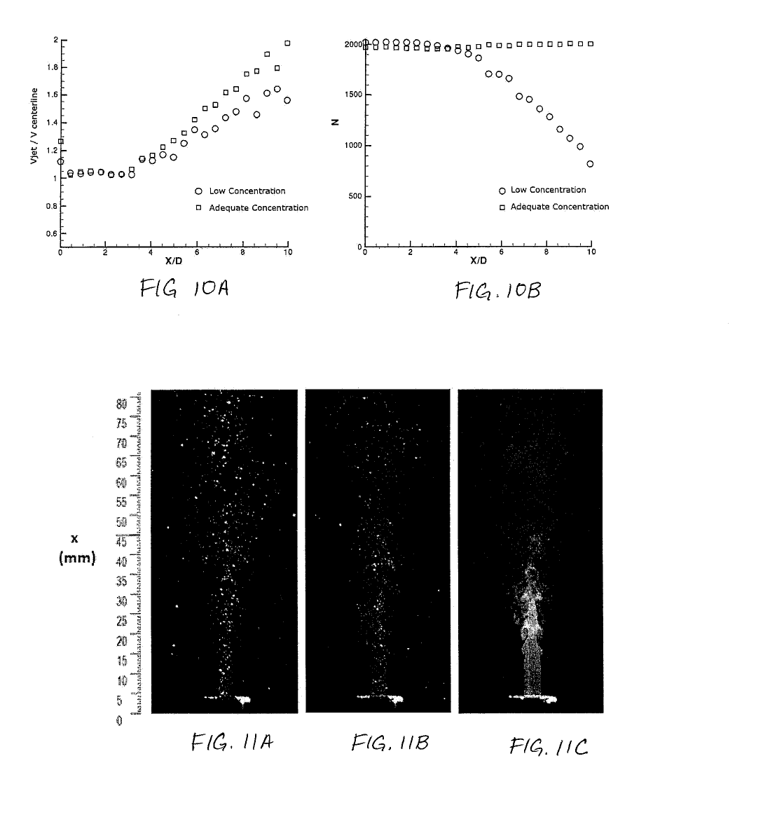

The number of valid vectors along the centerline of the jet for the jet conditions explored in FIG. 7 is presented in FIG. 8. It confirms that, at sufficiently high/medium jet flow rate (e.g., 15 m/s), the mechanically agitated fluidized bed (MFS) provides comparable seeding to that of the NS. However, FIG. 8 clearly demonstrates that the MFS seeding quality deteriorates as the jet flow rate drops quickly farther downstream of the jet, which is an indication that MFS performance depends on the jet flowrate. The effect of the concentration of particles on PIV velocity measurements is presented in FIG. 9 for a laminar regime (Re=1800) and in FIG. 10 for a transient laminar-turbulent regime (Re=3900). Figures (a) and (b) present, respectively, the jet decay along the centreline and the corresponding valid PIV velocity vectors. FIGS. 9 and 10 show that as the seeding concentration in the jet drops below a certain concentration level (FIGS. 9(b) and 10(b)), the mean-velocity profile (FIGS. 9(a) and 10(a)) deviates or fluctuates noticeably around the one that corresponds to adequate concentration level.

### Particles Size

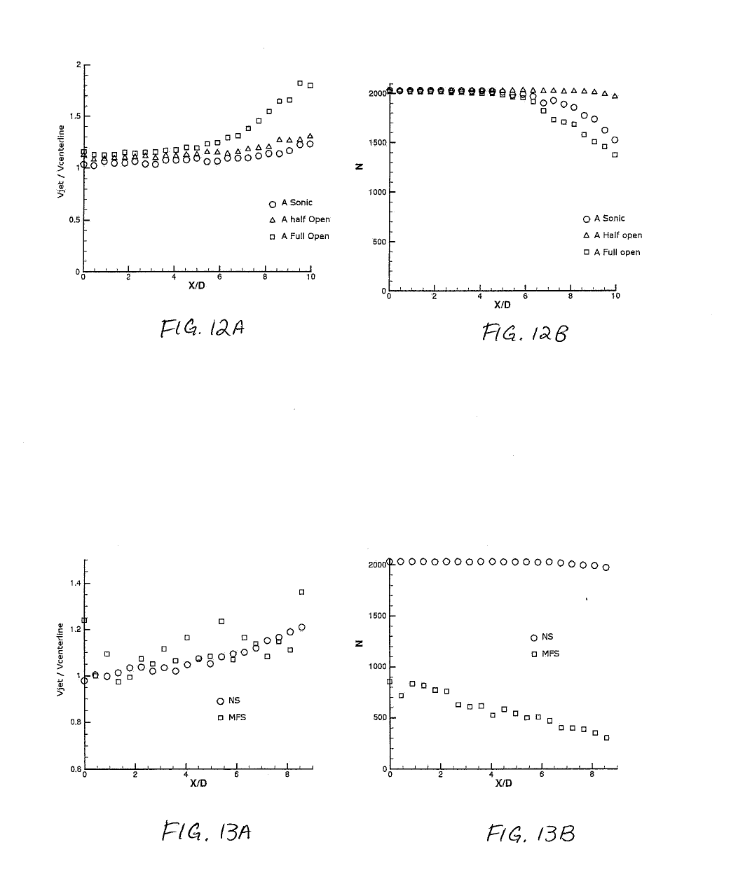

FIG. 11 illustrates the effect of the new seeder sonic valve in breaking up the agglomerated particles into smaller size. These instantaneous images are an illustration of the effect of the sonic valve on the size of TiO₂ particles in the near field of a jet at low flow rate. FIG. 11(a) shows that when the valve is fully open, the flow appears to be seeded by a wide range of particles size including large particles. FIG. 11(b) shows that even though the valve is not in sonic position, the increased shears stress at valve by reducing the exit cross sectional area, breaks down many larger agglomerates into smaller ones. In other words, the concentration of the very large particles seen in FIG. 11(a) is reduced. On the other hand, FIG. 11(c) clearly shows that maximum shear stress at a sonic condition of the valve breaks down all particle agglomerates into small agglomerated particles. Moreover, sonic position of the valve results in a uniform size distribution of particles in the jet flow (FIG. 11(c)).

The effects of the sonic valve on the velocity measurements along the centerline of the jet are shown in FIG. 12. FIG. 12(b) shows that although, there are enough particles to generate valid PIV vectors (this is done by adjusting the brush rotational speed to increase the particles concentration when the valve is fully or half open) in all positions of the valve (FIG. 12(b)), FIG. 12(a) shows that the corresponding jet velocity decay profiles do not overlap. This is because of the larger particles formed when the sonic valve is either fully or half open.

### New Seeder Versus Existing Seeders

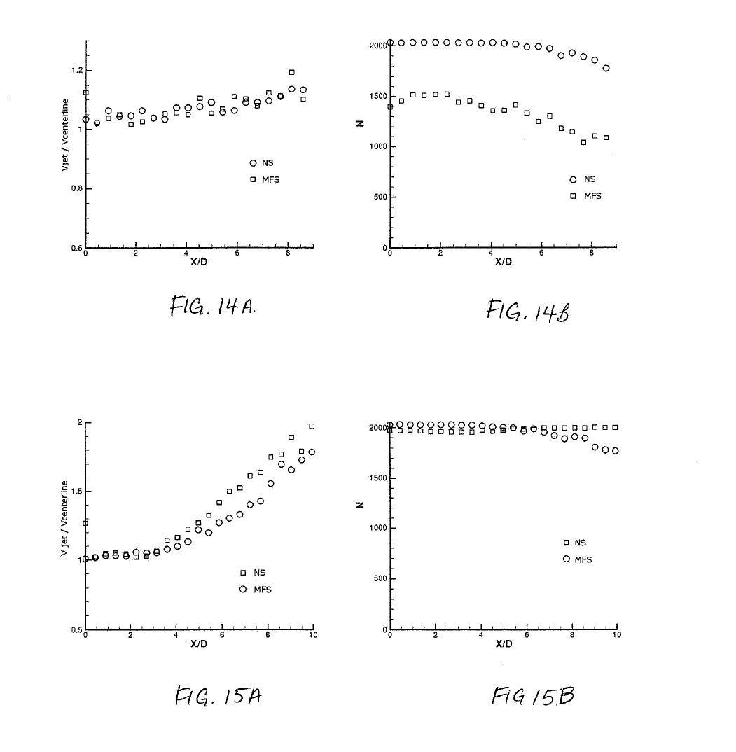

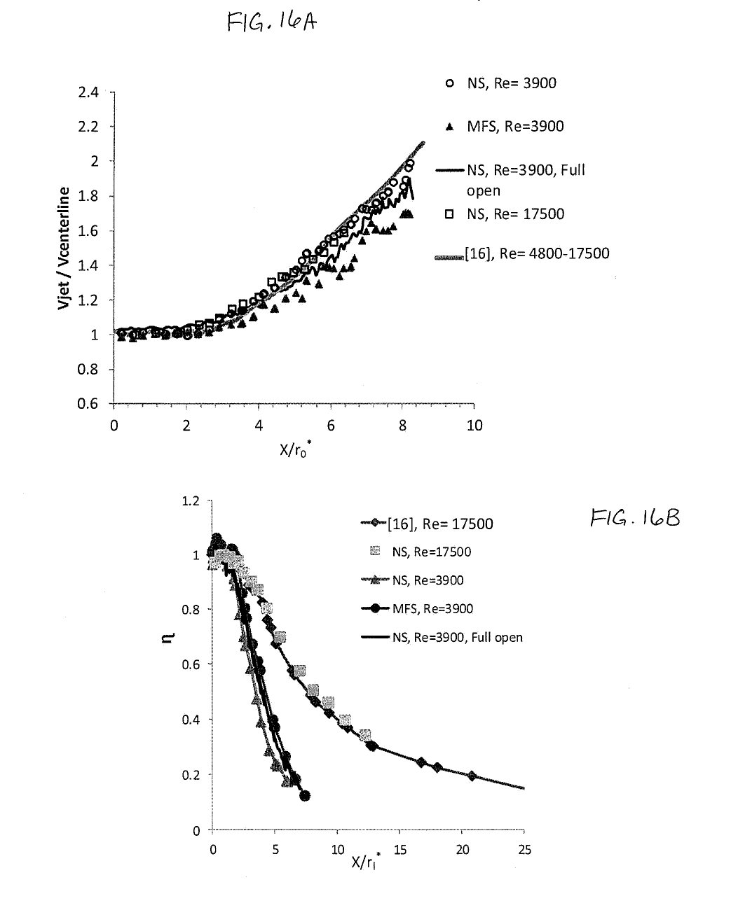

In order to evaluate the performance of the new seeder (NS) at different flow rates, the profiles of the jet mean-velocity decay are compared between the mechanically agitated fluidized-bed seeder (MFS) and new seeder (NS). FIG. 13, which is for a very low flow rate with a jet exit velocity of about 3.7 m/s (Re=800), shows that the mechanically agitated fluidized bed has a fluctuating profile of the jet centerline velocity decay. This is mainly due to its poor seeding as it can be seen in FIG. 13(b); whereas the NS results in a smoother jet velocity decay profile. FIG. 14, which is for a moderately higher flow rate (i.e., with a jet velocity of about 8 m/s; that is for Re 1800), shows that the MFS performs better than before as its corresponding mean-velocity decay profile's fluctuations decreased but still not enough to provide a smooth profile. This clearly shows the dependence of the seeding of the flow by the MFS on the jet flow rate. FIG. 15 presents the profiles for a much higher flow rate than in the cases of FIGS. 13 and 14 where the jet exit velocity is about 15 m/s (Re 3900). FIG. 15(b) shows that, at this relatively high flow rate, the MFS supplies enough particles into the flow. FIG. 15(a), however, shows that the MFS jet has a decay profile that is still slightly different than its NS counterparts. This is due to larger particles agglomerates generated by the MFS.

### Performance and Validations

The new seeder is tested for flowrates between 3.70 LPM and 150 LPM. The seeder could operate bellow 3.70 LMP but the flow rate was restricted by the minimum range of the flowmeter. Also, the higher range of 150 LPM is limited by the speed and resolution of the camera due to the high speed of the jet; however, the new seeder could operate at higher than 150 LPM. Measuring the mean velocity and turbulence intensity of a jet at high speed can be achieved by using a bypass line in order to reduce the over flow into the seeder.

FIG. 16 presents a comparison of the centreline mean-velocity decay (FIG. 16(a)) and its corresponding turbulence intensity (FIG. 16(b)) for a jet seeded by MFS or NS with their counterparts published results obtained using hot wire anemometry, which is an independent technique (as it does not employ seeding). FIG. 16(a) clearly shows that both the centreline decay of the jets seeded by the NS with a sonic valve agree well with their counterparts obtained by hot wire anemometry [16] over the range of Re=3,900-17,500; whereas the centreline decay profile of the jet seeded by the MFS shows lower values than the corresponding published profiles. The same figure shows also that the decay profile of the jet flow seeded with the new seeder but with the sonic valve fully open has a noticeably lower profile than that of the jet with a sonic valve configuration. FIG. 16(b) shows that the centreline turbulence intensity of the jet seeded by the new seeder overlaps its corresponding published counterpart at Re=17,500. The same figure shows that the centreline turbulence intensity of the jet seeded by the MFS is not in agreement with that seeded with the new seeder when a sonic valve is used. The same figure shows also that the jet seeded by the new seeder with the sonic valve not used (i.e., fully open) has a different (higher) turbulence intensity profile than its counterpart with the sonic valve being used. This figure is evidence of the superior performance of the new seeder, not only in generating adequate/proper particles to seed the jet flow, but also in breakup up large particles and hence provide uniform particles size.

### CONCLUSIONS

The sample results of the in-house developed new seeder described herein shows that a steady amount of uniform size particles can be supplied into a gaseous jet flow independently of its flow rate. The concentration of the particles in the flow can be adjusted by a simple control of the rotational speed of a brush without affecting the jet flow rate. The designed sonic valve has also been shown to help keep the particles as small as possible and also reduces significantly the possibility of clogging. It is believed that this seeder of the present invention can perform adequately with any flow condition (i.e., ultra low, low, medium, or high flow rate). It is also believed that the seeder of the present invention can be used in large volume flows (such as in wind tunnels) where a high quantity of tracers/particles is needed.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

### REFERENCES

The following references referred to by number above are hereby incorporated by reference.
[1] Melling A 1997 Tracer particles and seeding for particle image velocimetry Measurement Science and Technology 8(12) 1406-1416
[2] Tropea C, Yarin A L and Foss J F 2007 Handbook of Experimental Fluid Mechanics, Volume 1, Springer.
[3] Pierce A J and Lu F K 2011 New Seeding and Surface Treatment Methods for Particle Image Velocimetry 49th AIAA Aerospace Sciences Meeting including the New Horizons Forum and Aerospace Exposition (4-7 January, Orlando, Fla., p. 1164)
[4] Smelker K P 2006 Generating Uniform Sub-micron Solid Particles for Laser-based Flow Diagnostics Undegraduate Final Year Project Thesis The Ohio State University, USA.
[5] Willert C and Janus M 2002 Planar flow field measurements in atmospheric and pressurized combustion chambers Experiments in Fluids 33 931-939
[6] Crosswy F L 1985 Particle size distributions of several commonly used seeding aerosols NASA CP-2393, pp. 53-75
[7] Thomas L M 2009 Flow Measurements Using Particle Image Velocimetry in the Ultracompact Combustor MSc Thesis Air Force Institute of Technology, Ohio, USA
[8] McNiel C M, Peltier D W, Reeder M F and Crafton J W 2007 Clean Seeding for Particle Image Velocimetry 22nd International Congress on Instrumentation in Aerospace Simulation Facilities (IEEE, pp. 1-6)
[9] DeLapp C J 2006 Particle image velocimetry using novel non-intrusive seeding MSc Thesis Air Force Institute of Technology, Ohio, USA [10] Raffel M, Willert C E, Wereley S T and Kompenhans J 2007 Particle Image Velocimetry: A Practical Guide, Springer.
[11] Howison J C and Goyne C P 2010 Assessment of Seeder Performance for Particle Velocimetry in a Scramjet Combustor Journal of propulsion and power 26(3) 514-523
[12] Urban W and Mungal M 1997 Planar velocity measurements in compressible mixing layers 35th Aerospace Sciences Meeting (AIAA 97-0757, Reno, Nev., pp. 1-15)
[13] Iyogun C O and Birouk M 2009 On the Stability of a Turbulent Non-Premixed Methane Flame Combustion Science and Technology 181(12) 1443-1463
[14] Iyogun C O Birouk M and Kozinski J A 2011 Experimental investigation of the effect of fuel nozzle geometry on the stability of a swirling non-premixed methane flame Fuel 90(4) 1416-1423
[15] Iyogun C O 2009 Effect of nozzle geometry on the stability of a turbulent jet flame with and without swirling co-flow PhD Thesis The University of Manitoba, Canada.
[16] Papadopoulos G and Pitts W 1999 Generic Centerline Velocity Decay Curve for Initially Turbulent Axisymmetric Jets Journal of Fluid Engineering 121 80-85.

1. A seeding apparatus for seeding a carrier fluid with particulate tracing material, the apparatus comprising:
a seeding chamber including an upper flow area arranged to receive a flow of the carrier fluid therethrough and a lower sump area below the upper flow arrange arranged to receive the tracing material therein;
a fluid inlet in communication with the upper flow area of the seeding chamber at a location above the lower sump area so as to be arranged to introduce the carrier fluid into the seeding chamber therethrough;
a fluid outlet in communication with the upper flow area of the seeding chamber at a location above the lower sump area so as to be arranged to discharge the carrier fluid from the seeding chamber therethrough; and
an agitator operatively supported in the seeding chamber so as to be arranged to agitate tracing material in the sump area of the seeding chamber.

2. The apparatus according to claim 1 wherein the fluid inlet and the fluid outlet are located in proximity to respective horizontally opposed ends of the seeding chamber.

3. The apparatus according to claim 1 wherein the agitator is supported for rotation about a generally horizontal axis between the flow area and the sump area.

4. The apparatus according to claim 1 wherein the seeding chamber is elongate in a longitudinal direction between the fluid inlet and the fluid outlet wherein the agitator is supported for rotation about an axis extending in the longitudinal direction.

5. The apparatus according to claim 1 further comprises an adjustable speed motor coupled to the agitator to drive rotation of the agitator between the sump area and the flow area of the seeding chamber.

6. The apparatus according to claim 1 wherein the agitator is supported for rotation relative the seeding chamber about a longitudinal axis and wherein the agitator includes a plurality of mixing elements oriented radially relative to the longitudinal axis for rotation between the upper flow area and the lower sump area.

7. The apparatus according to claim 6 wherein each mixing element comprises a planar body.

8. The apparatus according to claim 7 wherein each planar body is perforated.

9. The apparatus according to claim 1 wherein the agitator is driven to rotate relative to the seeding chamber by a drive shaft protruding through a wall of the seeding chamber and wherein there is provided a pressure chamber surrounding the drive shaft externally of the seeding chamber which is arranged to be pressurized.

10. The apparatus according to claim 1 wherein the inlet coupling includes an access opening arranged to introduce tracing material into the seeding chamber therethrough and a cap arranged to selectively enclose the access opening.

11. The apparatus according to claim 10 wherein the inlet coupling communicates through a top wall of the seeding chamber.

12. The apparatus according to claim 1 further comprising a bypass line connected in parallel relationship with the seeding chamber so as to receive a flow of the carrier fluid therethrough, the bypass line and the inlet coupling each being connected in series with a respective control valve and the control valves being connected to a common supply of the carrier fluid.

13. The apparatus according to claim 1 further comprising a sonic valve assembly in communication with the fluid outlet of the seeding chamber, the sonic valve assembly comprising:
a valve body having an inlet opening, an outlet opening, and a valve seat defining a valve opening between the inlet opening and the outlet opening; and
a valve member received within the valve body and being movable relative to the valve opening in an axial direction of the outlet opening so as to adjust an effective size of the valve opening.

14. The apparatus according to claim 13 wherein the valve seat comprises a generally conical surface which is reduced in diameter towards the valve opening in a direction from the inlet opening towards the outlet opening.

15. The apparatus according to claim 13 wherein the valve member includes an end portion which is generally conical so as to be reduced in diameter towards an apex in the axial direction.

16. The apparatus according to claim 13 wherein the valve member is supported relative to the valve body by a threaded connection so as to adjust a position of the valve member relative to the valve body by rotation of the valve member relative to the valve body.

17. A sonic valve assembly for receiving a flow of carrier fluid containing particulate tracing material therein, the valve assembly comprising:
a valve body having an inlet opening, an outlet opening, and a valve seat defining a valve opening between the inlet opening and the outlet opening; and
a valve member received within the valve body and being movable relative to the valve opening in an axial direction of the outlet opening so as to adjust an effective size of the valve opening.

18. The apparatus according to claim 17 wherein the valve seat comprises a generally conical surface which is reduced in diameter towards the valve opening in a direction from the inlet opening towards the outlet opening.

19. The apparatus according to claim 17 wherein the valve member includes an end portion which is generally conical so as to be reduced in diameter towards an apex in the axial direction.

20. The apparatus according to claim 17 wherein the valve member is supported relative to the valve body by a threaded connection so as to adjust a position of the valve member relative to the valve body by rotation of the valve member relative to the valve body.
